(19) United States
(12) Patent Application Publication
(10) Pub. No.: US 2012/0189840 A1
(43) Pub. Date: Jul. 26, 2012

(54) OA ROLLER AND COATING MATERIAL FOR OA ROLLER

(76) Inventor: Munehiro NISHIMOTO, Kobe-shi (JP)

(21) Appl. No.: 13/315,788

(22) Filed: Dec. 9, 2011

(30) Foreign Application Priority Data
Jan. 20, 2011 (JP) 2011-010190

(51) Int. Cl. B32B 15/08; B32B 27/20; C08K 3/34

(52) U.S. Cl. 428/330; 524/445; 428/450; 428/425.8; 428/331

(57) ABSTRACT

The OA roller according to the present invention includes a roller body made of a metal and a coating layer formed on an outside surface of the roller body, while the coating layer is composed by applying a coating material containing binder resin having hardenability, a pigment, amino resin as a crosslinking agent for the binder resin, and attapulgite of not less than 1 part by mass and not more than 8 parts by mass with respect to 100 parts by mass of the binder resin to the outside surface of the roller body and hardening and crosslinking the binder resin.

### BACKGROUND OF THE INVENTION

1. Field of the Invention

The present invention relates to an OA roller, including a roller body made of a metal and a coating layer composed on an outside surface thereof, employed as a driving roller or the like in an OA machinery such as an electrostatic copier, for example, and a coating material for an OA roller for composing the coating layer of the OA roller.

2. Description of Related Art

An OA roller such as a driving roller or the like for rotating/driving a paper feeding belt, a transfer belt, an intermediate transfer belt or the like is frequently employed in an OA machinery such as an electrostatic copier, a laser printer, a plain paper facsimile or a composite machine thereof.

In such an OA roller, an outside surface of a roller body made of a metal may be covered with a coating layer for preventing sliding with respect to a belt or the like, or a surface of the coating layer may be roughened, in order to prevent sliding with respect to a belt or the like.

### SUMMARY OF THE INVENTION

Following the recent increase in the printing speed of the electrostatic copier or the like, however, the OA roller subjected to the conventional processing cannot effectively prevent the sliding with respect to the belt over a long period, but the sliding is disadvantageously caused in a relatively short period.

This is conceivably because the driving roller or the like so repeatedly comes into contact with the belt or the like over a long time that the roughened outside surface is abraded to reduce the frictional force or the coating layer peels from the outside surface of the roller body to be lost.

In addition to the problem of the sliding, the OA roller easily causes such problems that the coating layer partially deforms or adheres to the belt or the like when the electrostatic copier or the like is stopped in a service condition such as a high-temperature and high-humidity environment, the coating layer adhesive to the belt or the like peels from the outside surface of the roller body, and fragments of the peeling coating layer enter other portions of the electrostatic copier or the like to influence a formed image.

As to a coating material containing hardenable binder resin such as urethane resin for forming a coating layer, therefore, the inventor has studied a countermeasure of adding a crosslinking agent for the binder resin to the coating material thereby increasing the crosslinking density of the hardened binder resin. Thus, the coating layer can be prevented from partially deforming or adhering to a belt or the like.

The inventor has also studied a countermeasure of adding various pigments to the coating material.

When an extender such as clay, for example, is added to the coating material, peeling of the coating layer can be prevented by relaxing film shrinkage in hardening of the binder resin and improving adhesion of the hardened coating layer to the outside surface of the roller body made of the metal.

When a pigment such as a zinc oxide whisker, for example, having needlelike protrusions is added to the coating material, the protrusions protrude from the surface of the coating layer as microprotrusions, whereby the friction coefficient of the OA roller can be improved due to a scratching effect with the belt, and the high friction coefficient can be maintained over a long period.

Depending on the type of the pigment, however, the pigment easily separates or precipitates in a relatively short period during storage of the prepared coating material. This tendency remarkably appears particularly in a pigment having large specific gravity.

In order to improve storage stability of the coating material by preventing the pigment from separation and precipitation regardless of the type thereof, therefore, the inventor has studied a countermeasure of introducing a viscosity modifier, i.e., the so-called thixotropy agent to the coating material thereby supplying the same with thixotropy.

When supplied with the thixotropy, the coating material remains highly viscous in a stationary state such as a storage state with no application of shear stress, and hence the pigment can be prevented from separation and precipitation.

Therefore, the inventor has studied various viscosity modifiers. However, a general viscosity modifier disadvantageously easily bleeds from the coating layer in a high-temperature and high-humidity environment, reduces the adhesion or the friction coefficient of the coating layer, or bubbles in preparation of the coating material to deteriorate the appearance of the coating layer.

When the viscosity modifier bleeds from the coating layer, the coating layer adheres to the belt or the like when the electrostatic copier or the like is stopped in the service condition such as the high-temperature and high-humidity environment, the coating layer adhering to the belt or the like separates from the outside surface of the roller body, and fragments of the peeling coating layer enter other portions of the electrostatic copier or the like to influence the formed image.

Further, toner or paper dust adheres to the bleeding component due to operation of the electrostatic copier or the like, to easily deposit between the roller and the belt in particular, and influence the formed image.

An object of the present invention is to provide an OA roller capable of maintaining excellent characteristics over a long period without causing problems resulting from addition of a viscosity modifier to a coating material, with a coating layer composed on an outside surface of a roller body made of a metal neither abrading nor deforming in a short period and neither adhering to nor peeling from a belt or the like.

Another object of the present invention is to provide a coating material for an OA roller suitable for forming the coating layer of the OA roller and excellent in storage stability due to a viscosity modifier contained therein.

In order to solve the aforementioned problems, the inventor has further studied a viscosity modifier. As a result, the inventor has found that fine powder of attapulgite (hydrous magnesium-aluminum silicate) which is a kind of clay mineral may be employed as the viscosity modifier.

The attapulgite is solid in the coating layer, and does not move in the layer. Further, the attapulgite is in the form of fine fiber, and hence filaments of the fiber are so entwined with one another that strong viscosity (thixotropy) can be developed when the attapulgite is introduced into the coating material.

Therefore, the attapulgite supplies excellent thixotropy to the coating material to prevent separation and precipitation of a pigment without bleeding from the coating layer particularly in a high-temperature and high-humidity environment, reducing the adhesion or the friction coefficient of the coating layer or bubbling in preparation of the coating material to deteriorate the appearance of the coating layer. Therefore, the attapulgite can improve storage stability of the coating material without causing the aforementioned problems.

Accordingly, the present invention provides an OA roller including a coating layer formed by applying a coating material containing binder resin having hardenability, a pigment and amino resin as a crosslinking agent for the binder resin to an outside surface of a roller body made of a metal and thereafter hardening and crosslinking the binder resin, while the coating material contains attapulgite of not less than 1 part by mass and not more than 8 parts by mass with respect to 100 parts by mass of the binder resin.

The present invention also provides a coating material for an OA roller, including a coating layer provided on an outside surface of a roller body made of a metal, for forming the coating layer, containing binder resin having hardenability, a pigment, amino resin as a crosslinking agent for the binder resin, and attapulgite of not less than 1 part by mass and not more than 8 parts by mass with respect to 100 parts by mass of the binder resin.

According to the present invention, the content of the attapulgite is limited to the range of not less than 1 part by mass and not more than 8 parts by mass with respect to 100 parts by mass of the binder resin for the following reasons:

If the content of the attapulgite is less than the above range, the effect of supplying thixotropy to the coating material by introducing the attapulgite into the coating material thereby preventing separation and precipitation of the pigment is not attained, and hence storage stability of the coating material is reduced.

If the content of the attapulgite exceeds the above range, on the other hand, viscosity (thixotropy) is so excessively increased that the coating material is inferiorly degassed (defoamed) in preparation thereof to deteriorate the appearance of the coating layer or reduce the friction coefficient of the coating layer.

The attapulgite is preferably in the form of fine powder having an average particle size of not more than 1 μm. Such fine powder of the attapulgite is particularly excellent in function as the viscosity modifier.

The binder resin is preferably aqueous urethane resin. The coating material containing the aqueous urethane resin can be prepared by employing water as a solvent, and hence a load exerted on the environment can be reduced.

The pigment preferably includes an extender. The extender has an excellent effect of preventing film shrinkage in hardening of the binder resin.

The pigment preferably includes a pigment having needlelike protrusions. The needlelike protrusions of the pigment have excellent effects of protruding from a surface of the coating layer as microprotrusions thereby improving the friction coefficient of the OA roller due to a scratching effect with a belt and maintaining the high friction coefficient over a long period.

According to the present invention, an OA roller capable of maintaining excellent characteristics over a long period without causing problems resulting from addition of a viscosity modifier to a coating material, with a coating layer formed on an outside surface of a roller body made of a metal neither abrading nor deforming in a short period and neither adhering to nor peeling from a belt or the like can be provided.

According to the present invention, further, a coating material for an OA roller suitable for forming the coating layer of the OA roller and excellent in storage stability due to a viscosity modifier contained therein can be provided.

The foregoing and other objects, features and effects of the present invention will become more apparent from the following detailed description of the embodiments with reference to the attached drawings.

### BRIEF DESCRIPTION OF THE DRAWINGS

FIG. 1 is a diagram for illustrating an outline of an apparatus employed for measuring a friction coefficient of a surface of a coating layer of an OA roller according to the present invention with respect to a belt.

### DETAILED DESCRIPTION OF PREFERRED EMBODIMENTS

The present invention provides an OA roller including a coating layer formed by applying a coating material containing binder resin having hardenability, a pigment and amino resin as a crosslinking agent for the binder resin to an outside surface of a roller body made of a metal and thereafter hardening and crosslinking the binder resin, while the coating material contains attapulgite of not less than 1 part by mass and not more than 8 parts by mass with respect to 100 parts by mass of the binder resin.

The present invention also provides a coating material for an OA roller, including a coating layer provided on an outside surface of a roller body made of a metal, for forming the coating layer, containing binder resin having hardenability, a pigment, amino resin as a crosslinking agent for the binder resin, and attapulgite of not less than 1 part by mass and not more than 8 parts by mass with respect to 100 parts by mass of the binder resin.

The binder resin can be prepared any resin having hardenability and capable of increasing crosslinking density by reacting with the amino resin serving as the crosslinking agent, and is preferably prepared from aqueous urethane resin in particular. The coating material containing the aqueous urethane resin can be prepared by employing water as a solvent, and hence a load exerted on the environment can be reduced.

The aqueous urethane resin, not particularly restricted, can be prepared from one or more of Permarin (registered trademark) UA-300, UA-310 and UA-368 which are aqueous emulsions of polycarbonate-based polyurethane resin by Sanyo Chemical Industries, Ltd., Permarin UA-50 which is an aqueous solution of polyether-based polyurethane resin by Sanyo Chemical Industries, Ltd., Permarin UA-150 and UC-20 which are emulsions of polyether-based polyurethane resin by Sanyo Chemical Industries, Ltd., Superflex (registered trademark) E-4000 which is an emulsion of polyether-based polyurethane resin by Dai-ichi Kogyo Seiyaku Co., Ltd. and the like, for example.

The amino resin can be prepared from any amino resin such as melamine resin, urea resin, guanamine resin or the like, for example, capable of functioning as a crosslinking agent for the aqueous urethane resin.

The amino resin, not particularly restricted, can be prepared from one or more of Cymel (registered trademark) 323, 325, 327, 328 and 385 which are solutions of methylated high iminomelamine resin by Cytec Industries Inc., Cymel 370, 373 and 3749 which are solutions of partially methylated melamine resin by Cytec Industries Inc., Uban (registered trademark) 120 which is a solution of n-butylated melamine resin by Mitsui Chemicals Inc., Melan (registered trademark) 552 which is a solution of methyl-etherified melamine resin by Hitachi Chemical Co., Ltd. and the like, for example.

The content of the amino resin is preferably not less than 15 parts by mass and particularly preferably not less than 25 parts by mass with respect to 100 parts by mass of the binder resin, and preferably not more than 55 parts by mass and particularly preferably not more than 45 parts by mass.

If the content of the amino resin is less than the above range, the effect of increasing the crosslinking density of the binder resin by introducing the amino resin thereby preventing the coating layer from partially deforming or adhering to the belt or the like particularly in a high-temperature and high-humidity environment or preventing the coating layer adhering to the belt or the like from peeling from the outside surface of the roller body may be insufficient.

If the content of the amino resin exceeds the above range, on the other hand, the crosslinking density of the binder resin is excessively increased to the contrary and the coating layer is excessively hardened, and hence the friction coefficient of the surface may be reduced to easily cause sliding with the belt or the like.

In either case, adhesion of the coating layer to the outside surface of the roller body tends to slightly lower.

When the aforementioned emulsion or aqueous solution is employed as the binder resin and the aforementioned solution is employed as the amino resin, the content of the amino resin is expressed in parts by mass of the solid component (the amino resin) in the solution with respect to 100 parts by mass of the solid component (the binder resin) in the emulsion or the aqueous solution.

The pigment is preferably prepared from the aforementioned extender excellent in the effect of preventing film shrinkage in the hardening of the binder resin.

The extender can be prepared from one or more of clay such as kaolin, precipitated barium sulfate, calcium carbonate, aluminum hydroxide, magnesium carbonate, talk, mica and the like, for example.

A pigment having needlelike protrusions is also preferable as the pigment.

The pigment having needlelike protrusions is particularly preferably prepared from a pigment having such a steric shape that not less than two needlelike protrusions radially protrude from the center, such as the so-called tetrapic pigment having four needlelike protrusions equiangularly protruding in all directions from the center, for example.

The pigment can be prepared from one or more of zinc oxide, magnesium oxide, aluminum borate, silicon carbide, silicon nitride, potassium titanate, basic magnesium sulfate, calcium sulfate, sodium calcium phosphate, magnesium borate, calcium carbonate, titanium diboride, gypsum, alumina, chrysotile, sepiolite, zonotolite and the like, for example. Alternatively, the pigment may be a mixture of star sand from Okinawa or the like.

In particular, the pigment is preferably prepared from a zinc oxide whisker having the tetrapic shape.

In the pigment, at least one of not less than two protrusions is buried in the coating layer to exhibit an anchor effect thereby preventing dropping of the pigment resulting from stimulation or abrasion of the belt while the remaining protrusion protrudes from the surface of the coating layer as a microprotrusion thereby improving the friction coefficient of the OA roller due to a scratching effect with the belt and functioning to maintain the high friction coefficient over a long period. Therefore, excellent characteristics of the OA roller can be maintained over a longer period. Alternatively, the pigment may be in the form of a needle as a whole.

As the pigment, a plurality of types of pigments such as the extender, the pigment having needlelike protrusions and the like having different functions are preferably employed. In this case, the excellent characteristics of the OA roller can be maintained over a longer period due to the synergistic effect of the functions of the pigments.

The content of the pigment is preferably not less than 25 parts by mass and particularly preferably not less than 45 parts by mass with respect to 100 parts by mass of the binder resin, and particularly not more than 120 parts by mass and particularly preferably not more than 100 parts by mass. When not less than two types of pigments are employed together, the total content of not less than two types of pigments employed together is preferably within the above range.

If the content of the pigment is less than the above range, the effect of relaxing film shrinkage in the hardening of the binder resin by introducing the pigment for increasing the adhesion of the hardened coating layer to the outside surface of the roller body made of a metal thereby preventing separation or the like may be insufficient.

If the content of the pigment exceeds the above range, on the other hand, the coating layer may be so fragile that the same easily peels from the outside surface of the roller body.

When the aforementioned emulsion or aqueous solution is employed as the binder resin, the content of the pigment is expressed in parts by mass with respect to 100 parts by mass of the solid component (the binder resin) in the emulsion or the aqueous solution.

The attapulgite can be prepared from any material having a shape, a state and the like for functioning as the viscosity modifier for the coating material and supplying thixotropy to the coating material thereby preventing separation and precipitation of the pigment.

Above all, powdery attapulgite, particularly fine powdery attapulgite having an average particle size of not more than 1 μm is suitably employed due to excellency in the function.

The lower limit, not particularly restricted, of the average particle size of the attapulgite is preferably not less than 0.05 μm, in consideration of handleability or the like in introduction into the coating material.

In consideration of such handleability and the function as the viscosity modifier for the coating material, the average particle size of the attapulgite is more preferably around 0.1 μm in the above range.

In the present invention, the average particle size of the attapulgite is expressed in a median diameter D50 of particle size distribution obtained by laser diffraction scattering or the like, for example.

The attapulgite, not particularly restricted, can be prepared from one or more of Attagel 50 (average particle size D50=0.1 μm) and Attagel 40 (average particle size D50=0.1 μm), trade names by Hayashi Kasei Co., Ltd. and the like, for example.

The content of the attapulgite is limited to not less than 1 part by mass and not more than 8 parts by mass with respect to 100 parts by mass of the binder resin.

If the content of the attapulgite is less than the above range, the effect of supplying thixotropy to the coating material by introducing the attapulgite thereby preventing separation and precipitation of the pigment is not attained, and hence the storage stability of the coating material is reduced.

If the content of the attapulgite exceeds the above range, on the other hand, the viscosity (thixotropy) of the coating material is so excessively increased that the coating material is inferiorly degassed (defoamed) in preparation thereof to deteriorate the appearance of the coating layer or reduce the friction coefficient of the coating layer.

In order to improve the storage stability of the coating material to the utmost without causing such problems in the coating layer, the content of the attapulgite is preferably not less than 2.5 parts by mass in the above range, and preferably not more than 7.5 parts by mass and particularly preferably not more than 5 parts by mass.

In addition to the components, various well-known additives such as a defoaming agent, a dispersion stabilizer, a surface tension regulator and the like can also be introduced into the coating material at arbitrary ratios.

The coating material is desirably prepared as an aqueous coating material employing water as a solvent as hereinabove described, in order to reduce a load applied to the environment.

When binder resin supplied in the state of an aqueous emulsion or an aqueous solution as hereinabove described is employed, for example, the aqueous coating material is obtained by adding the pigment, the amino resin and the attapulgite to the emulsion or the aqueous solution to be in the prescribed contents and adding other additives as necessary.

The viscosity of the coating material may be adjusted by further adding water, a mixed solvent of water and an aqueous organic solvent or the like as necessary.

The coating material is supplied with thixotropy due to the addition of the attapulgite as the viscosity modifier and remains highly viscous in a stationary state such as a storage state with no application of shear stress, and hence the storage stability can be improved by preventing separation and precipitation of the pigment.

Further, the attapulgite neither bleeds from the coating layer in the high-temperature and high-humidity environment, nor reduces the adhesion or the friction coefficient of the coating layer, nor bubbles in preparation of the coating material to deteriorate the appearance of the coating layer, dissimilarly to other viscosity modifiers.

The OA roller is obtained by forming the coating layer by applying the coating material to an outside surface of a cylindrical or columnar roller body made of a metal such as aluminum, copper, brass, stainless steel or the like, for example, by an arbitrary method such as spray coating, thereafter drying the same for removing the solvent such as water, and further heating the coating material thereby hardening the binder resin and crosslinking the same due to the action of the amino resin serving as the crosslinking agent.

The OA roller does not cause various problems dissimilarly to a case of employing a viscosity modifier other than the attapulgite as described above, while the coating layer composed on the outside surface of the roller body made of a metal layer is neither abraded nor deformed in a short period and neither adheres to nor separates from the belt or the like. Thus, the OA roller can maintain excellent characteristics over a long period.

The friction coefficient μ of the surface of the OA roller with respect to the belt combined therewith is preferably not less than 0.3 and particularly preferably not less than 0.6. If the friction coefficient μ is less than the above range, the OA roller may so easily cause sliding between the same and the belt that the belt cannot be excellently driven.

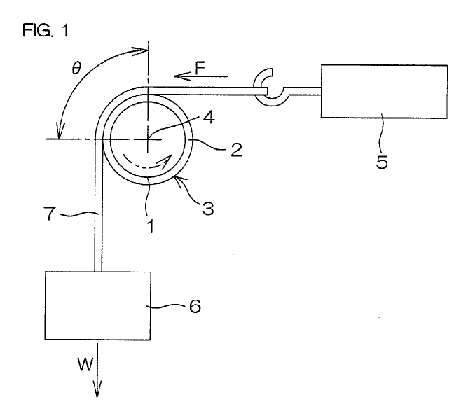

In the present invention, the friction coefficient μ is expressed in a value measured by a method according to Euler's belt formula with an apparatus shown in FIG. 1.

An OA roller 3 having a coating layer 2 composed on an outside surface of a roller body 1 made of a metal as described above is held to be rotatable in a direction shown by arrow of a two-dot chain line in FIG. 1, in a state directing a central axis 4 of the roller body 1 in the horizontal direction. A load meter 5 is arranged in the vicinity of the OA roller 3, in a state keeping the distance between the same and the central axis 4 of the OA roller 3 constant.

Then, a second end of a belt 7 having a first end mounted with a weight 6 having mass W (G) is connected to the load meter 5, and the belt 7 is brought into contact with a surface of the coating layer 2 of the OA roller 3 over the range of a central angle θ (° centering on the central axis 4, in a state suspending the first end of the belt 7 closer to the weight 6 downward beyond the OA roller 3.

A load F (g) caused when the OA roller 3 is rotated in the direction shown by arrow of the two-dot chain line at a constant speed is measured with the load meter 5, and the friction coefficient μ is obtained from the load F (g), the mass W (g) of the weight 6 and the central angle θ (°) according to the following equation (1)

μ=(1/θ)ln(F/W) (1)

The thickness of application of the coating material for forming the coating layer is preferably not less than 20 μm, and preferably not more than 100 μm.

If the thickness of application of the coating material is less than the above range, the coating layer may not be formed with a uniform thickness.

If the thickness of application of the coating material exceeds the above range, on the other hand, the appearance of the coating layer may be deteriorated due to sagging or the like, and workability such as dryability may be reduced.

The OA roller according to the present invention can be suitably employed as a driving roller or the like for rotating/driving a paper feeding belt, a transfer belt, an intermediate transfer belt or the like in an OA machinery such as an electrostatic copier, a laser printer, a plain paper facsimile or a composite machine thereof, for example.

### EXAMPLES

In each of the following Examples and comparative examples, preparation of a coating material, manufacturing of an OA roller and tests were executed in an environment having a temperature of 23±5° C. and relative humidity of 55±5%, unless otherwise stated.

### Example 1

A coating material was prepared by blending an isobutanol solution of methylated high iminomelamine resin [the aforementioned Cymel 327 by Cytec Industries Inc., solid concentration: 88 to 92 mass %], clay as an extender [hydrous kaolin-based, ASP-170 by BASF Japan], a zinc oxide whisker as a pigment having needlelike protrusions [tetrapic, Panatetra (registered trademark) by Panasonic Corporation] and attapulgite as a viscosity modifier [the aforementioned Attagel 50, trade name by Hayashi Kasei Co., Ltd., average particle size D50=0.1 μm] into aqueous polycarbonate-based polyurethane resin [an emulsion, the aforementioned Permarin UA-300 by Sanyo Chemical Industries, Ltd., solid concentration: 38 mass %].

The contents of the methylated high iminomelamine resin (a solid component of Cymel 327), the clay, the zinc oxide whisker and the attapulgite with respect to 100 parts by mass of the polycarbonate-based polyurethane resin (a solid component of Permarin UA-300) as the binder resin in the coating material were set to 36 parts by mass, 30 parts by mass, 35 parts by mass and 2.5 parts by mass respectively.

An OA roller was manufactured by applying the coating material to an outside surface of a roller body made of aluminum (A6063) having an outer diameter of φ24 mm and a length of 220 mm by spray coating, drying the coating material by keeping the same at room temperature for about 30 minutes, then predrying the coating material at 90° C. for 10 minutes and thereafter heating the same at 140° C. for 15 minutes thereby hardening and crosslinking the binder resin and forming a coating layer.

### Comparative Example 1

An OA roller was manufactured by preparing a coating material similarly to Example 1, except that no attapulgite was blended.

### Examples 2 and 3 and Comparative Example 2

In each of Examples 2 and 3 and comparative example 2, an OA roller was manufactured by preparing a coating material similarly to Example 1, except that the content of attapulgite with respect to 100 parts by mass of polycarbonate-based polyurethane resin as binder resin was set to 5 parts by mass (Example 2), 7.5 parts by mass (Example 3) or 10 parts by mass (comparative example 2).

### Comparative Example 3

An OA roller was manufactured by preparing a coating material similarly to Example 1, except that a denatured urea-based viscosity modifier [BYK (registered trademark)-420 by BYK Japan K.K.] was blended in place of the attapulgite. The content of the viscosity modifier was set to 0.5 parts by mass with respect to 100 parts by mass of polycarbonate-based polyurethane resin as binder resin.

### Accelerated Storage Stability Test

Each of the coating materials prepared according to Examples 1 to 3 and comparative examples 1 to 3 was introduced into a container of 300 ml by 80%, and the container was sealed and left in a thermostat of 50° C. for one month.

Then, the coating material was taken out of the thermostat along with the container, and cooled to room temperature. Then, the presence or absence of separation and precipitation was observed, to evaluate storage stability according to the following criteria:

∘: Neither separation nor precipitation was observed. Excellent in storage stability.

Δ: While separation and precipitation were observed, the coating material was easily re-dispersed by simply stirring the same with a spatula. Ordinary in storage stability.

X: Tightly precipitated, and the coating material was not easily re-dispersed by stirring the same with a spatula. Defective in storage stability.

### High Temperature and Humidity Test

A belt made of polyimide was directly brought into contact with the surface of the coating layer constituting the outside surface of the OA roller manufactured according to each of Examples 1 to 3 and comparative examples 1 to 3, and wound on the outside surface of the OA roller. Then, the OA roller was left in a high-temperature and high-humidity environment having a temperature of 60° C. and relative humidity of 80% for seven days, and the state of the OA roller was thereafter observed, to evaluate the coating layer according to the following criteria:

∘: The coating layer neither partially deformed nor adhered to the belt or the like.

X: The coating layer partially deformed or adhered to the belt or the like.

### Adhesion Test

Adhesion of the coating layer of the OA roller manufactured according to each of Examples 1 to 3 and comparative examples 1 to 3 was tested according to JIS K5600-5-6: 1999 “Testing Methods for Paints—Part 5: Mechanical Property of Film—Section 6: Adhesion Test: Cross-cut Test”, to evaluate the test result. In other words, the test result was classified in six stages according to Table 1 of JIS K5600-5-6, to determine classes 0 to 2 and 3 to 5 as excellent and defective in adhesion respectively.

### Evaluation of Appearance of Coating Layer

The appearance of the coating layer of the OA roller manufactured according to each of Examples 1 to 3 and comparative examples 1 to 3 was observed, and evaluated according to the following criteria:

∘: Absolutely normal. Excellent in appearance.

Δ: While small bubbles were observed with a magnifying glass of 10 magnifications, no abnormality was observed with the naked eye. Ordinary in appearance.

X: Bubbles were observed with the naked eye. Defective in appearance.

### Measurement of Friction Coefficient

The friction coefficient of the surface of the coating layer of the OA roller manufactured according to each of Examples 1 to 3 and comparative examples 1 to 3 with respect to the belt made of polyimide was obtained from a result measured with the aforementioned apparatus shown in FIG. 1 according to the above equation (1).

Table 1 shows the results.

TABLE 1

| | | | Comp. | | | | Comp. | Comp. |
|---|---|---|---|---|---|---|---|---|
| | | | Exam. 1 | Exam. 1 | Exam. 2 | Exam. 3 | Exam. 2 | Exam. 3 |
| Component | Permarin UA-300 | | 100 | 100 | 100 | 100 | 100 | 100 |
| | Cymel 327 | | 36 | 36 | 36 | 36 | 36 | 36 |
| | Pigment | ASP-170 | 30 | 30 | 30 | 30 | 30 | 30 |
| | | Panatetra | 35 | 35 | 35 | 35 | 35 | 35 |
| | | Total | 65 | 65 | 65 | 65 | 65 | 65 |
| | Viscosity Modifier | Attagel 50 | — | 2.5 | 5 | 7.5 | 10 | — |
| | | BYK-420 | — | — | — | — | — | 0.5 |

| | | | | | | | |
|---|---|---|---|---|---|---|---|
| Evaluation | Accelerated Storage Stability Test | x | ∘ | ∘ | ∘ | ∘ | ∘ |
| | High Temperature and Humidity Test | ∘ | ∘ | ∘ | ∘ | ∘ | x |
| | Adhesion (classification) | 0 | 0 | 0 | 0 | 0 | 0 |
| | Appearance | ∘ | ∘ | ∘ | o~Δ | x | ∘ |
| | Friction Coefficient μ | 0.67 | 0.67 | 0.65 | 0.62 | 0.60 | 0.65 |

From the results of comparative example 1 shown in Table 1, it has been proved that the pigment separates and precipitates to reduce the storage stability when the attapulgite serving as the viscosity modifier is not introduced into the coating material. From the results of comparative example 3, it has been proved that the viscosity modifier other than the attapulgite introduced into the coating material bleeds in a high-temperature and high-humidity environment to adhere to a belt or the like, although the storage stability is improved in this case.

From the results of Examples 1 to 3, on the other hand, it has been proved that excellent storage stability can be supplied to the coating material while preventing the problem of the bleeding or the like by introducing the attapulgite into the coating material as the viscosity modifier.

From the results of comparative example 2, however, it has been proved that excess attapulgite bubbles in preparation of the coating material to deteriorate the appearance of the coating layer or reduce the friction coefficient of the coating layer if the content of the attapulgite exceeds 8 parts by mass with respect to 100 parts by mass of the binder resin, and hence the content of the attapulgite must be not more than 8 parts by mass.

Comparing Examples 1 to 3 with one another, it has been proved that the content of the attapulgite is preferably not less than 5 parts by mass within the above range, and preferably not more than 7.5 parts by mass and particularly preferably not more than 5 parts by mass.

While the present invention has been described in detail by way of the embodiments thereof, it should be understood that these embodiments are merely illustrative of the technical principles of the present invention but not limitative of the invention. The spirit and scope of the present invention are to be limited only by the appended claims.

This application corresponds to Japanese Patent Application No. 2011-10190 filed with the Japan Patent Office on Jan. 20, 2011, the disclosure of which is incorporated herein by reference.

What is claimed is:

1. An OA roller comprising:
a roller body made of a metal; and
a coating layer composed on an outside surface of the roller body, wherein
the coating layer is formed by applying a coating material containing binder resin having hardenability, a pigment, amino resin as a crosslinking agent for the binder resin, and attapulgite of not less than 1 part by mass and not more than 8 parts by mass with respect to 100 parts by mass of the binder resin to the outside surface of the roller body and hardening and crosslinking the binder resin.

2. The OA roller according to claim 1, wherein
the attapulgite includes powdered attapulgite having an average particle size of not more than 1 μm.

3. The OA roller according to claim 1, wherein
the binder resin is aqueous urethane resin.

4. The OA roller according to claim 1, wherein
the pigment includes an extender.

5. The OA roller according to claim 1, wherein
the pigment includes a pigment having needlelike protrusions.

6. A coating material for an OA roller, including a roller body made of a metal and a coating layer formed on an outside surface of the roller body, for composing the coating layer,
containing binder resin having hardenability, a pigment, amino resin as a crosslinking agent for the binder resin, and attapulgite of not less than 1 part by mass and not more than 8 parts by mass with respect to 100 parts by mass of the binder resin.

7. The coating material for an OA roller according to claim 6, wherein
the attapulgite includes powdered attapulgite having an average particle size of not more than 1 μm.

8. The coating material for an OA roller according to claim 6, wherein
the binder resin is aqueous urethane resin.

9. The coating material for an OA roller according to claim 6, wherein
the pigment includes an extender.

10. The coating material for an OA roller according to claim 6, wherein
the pigment includes a pigment having needlelike protrusions.
